(19) United States
(12) Patent Application Publication
(10) Pub. No.: US 2016/0321937 A1
(43) Pub. Date: Nov. 3, 2016

(54) EDUCATIONAL SYSTEMS

(71) Applicant: Fawaz A. ALROUQI, Wilkes Barre, PA (US)

(72) Inventor: Fawaz A. ALROUQI, Wilkes Barre, PA (US)

(21) Appl. No.: 14/701,110

(22) Filed: Apr. 30, 2015

(51) Int. Cl. G09B 7/00; G09B 5/00

(52) U.S. Cl. CPC G09B 7/00; G09B 5/00

(57) ABSTRACT

A method and educational system includes circuitry that is configured to post assignments and grades. Graded assignments include one or more links or embedded tutorials pertinent to the graded assignments. The circuitry is also configured to advertise tutoring services and individual tutoring sessions, and stream educational events. The circuitry is also configured to link a jobs database to a job counseling center, host a private lesson platform, and link to one or more internal or external electronic libraries. The circuitry is also configured to provide a classroom viewing in session, and provide an evaluation platform for a student or an instructor.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention.

### BACKGROUND

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Many facets of an educational system have become automated in recent years. However, an active participant in an educational system needs to explore many different sources, each with its own organization, rules, and interface. This requires duplication of efforts, as well as risking the omission of certain information. In addition, many other facets still require physical documentation, which needs to be linked to the automated arena.

### SUMMARY

In one embodiment, an educational system includes circuitry configured to allow a teacher, through an assignment and grade posting application, to post an assignment to one or more students, receive a posted completed assignment by the one or more students, post one or more grades for the corresponding posted completed assignments, post a link or embedded tutorial associated with an incorrect or incomplete response for one or more of the posted completed assignments, and receive one or more follow-up responses to the graded assignments viewed by the one or more students. The educational system also includes circuitry configured to allow an instructor, through a tutoring application, to post an advertisement for a tutoring service, reply to posted inquiries from one or more students, arrange one or more tutoring sessions with the one or more students, and conduct the one or more tutoring sessions,. The educational system also includes circuitry configured to allow a teacher, principal, or administrator, via a web server, to stream one or more live educational events, post one or more recorded educational events, and provide a user interface for viewing the live and recorded educational events. The educational system also includes circuitry configured to allow an employer, through a jobs database and application, to post one or more job advertisements, receive one or more student applications in response to the one or more job advertisements, verify the one or more received student applications for meeting posted qualifications, forward the verified one or more received student applications that met the posted qualifications to a jobs center, and provide an appointment schedule for interviews offered by an interested posting entity to a qualified student. The educational system also includes circuitry configured to allow a teacher, principal, or administrator, through a classroom viewing application, to provide a log-in interface for an outside entity to view a classroom in session, verify log-in credentials of the outside entity, confirm authorization of the outside entity to view the classroom in session, and provide a viewing of the classroom in session after the verification and confirmation. The educational system also includes circuitry configured to allow an instructor, through a student evaluation application, to provide a completed evaluation of a student by the instructor, schedule an appointment with the student to discuss the completed evaluation, and receive responses from the evaluated student. The educational system also includes circuitry configured to allow a student, through a teacher evaluation application, to provide a completed evaluation of a teacher by the student, schedule an appointment with the student to discuss the completed evaluation, and receive responses from the evaluated teacher.

In another embodiment, a method of establishing an educational system includes allowing a teacher, through an assignment and grade posting application, to post an assignment to one or more students, receive a posted completed assignment by the one or more students, post one or more grades for the corresponding posted completed assignments, post a link or embedded tutorial associated with an incorrect or incomplete response for one or more of the posted completed assignments, and receive one or more follow-up responses to the graded assignments viewed by the one or more students. The method also includes allowing an instructor, through a tutoring application, to post an advertisement for a tutoring service, reply to posted inquiries from one or more students, arrange one or more tutoring sessions with the one or more students, and conduct the one or more tutoring sessions. The method also includes allowing a teacher, principal, or administrator, via a web server, to stream one or more live educational events, post one or more recorded educational events, and provide a user interface for viewing the live and recorded educational events. The method also includes allowing an employer, through a jobs database and application, to post one or more job advertisements, receive one or more student applications in response to the one or more job advertisements, verify the one or more received student applications for meeting posted qualifications, forward the verified one or more received student applications that met the posted qualifications to a jobs center, and provide an appointment schedule for interviews offered by an interested posting entity to a qualified student. The method also includes allowing a teacher, principal, or administrator, through a classroom viewing application, to provide a log-in interface for an outside entity to view a classroom in session, verify log-in credentials of the outside entity, confirm authorization of the outside entity to view the classroom in session, and provide a viewing of the classroom in session after the verification and confirmation. The method also includes allowing an instructor, through a student evaluation application, to provide a completed evaluation of a student by the instructor, schedule an appointment with the student to discuss the completed evaluation, and receive responses from the evaluated student. The method also includes allowing a student, through a teacher evaluation application, to provide a completed evaluation of a teacher by the student, schedule an appointment with the student to discuss the completed evaluation, and receive responses from the evaluated teacher.

In another embodiment, a non-transitory computer-readable storage medium having computer-readable instructions embodied thereon, that when executed by a computing device, executes a method. The method includes allowing a teacher, through an assignment and grade posting application, to post an assignment to one or more students, receive a posted completed assignment by the one or more students, post one or more grades for the corresponding posted completed assignments, post a link or embedded tutorial associated with an incorrect or incomplete response for one or more of the posted completed assignments, and receive one or more follow-up responses to the graded assignments viewed by the one or more students. The method also includes allowing an instructor, through a tutoring application, to post an advertisement for a tutoring service, reply to posted inquiries from one or more students, arrange one or more tutoring sessions with the one or more students, and conduct the one or more tutoring sessions. The method also includes allowing a teacher, principal, or administrator, via a web server, to stream one or more live educational events, post one or more recorded educational events, and provide a user interface for viewing the live and recorded educational events. The method also includes allowing an employer, through a jobs database and application, to post one or more job advertisements, receive one or more student applications in response to the one or more job advertisements, verify the one or more received student applications for meeting posted qualifications, forward the verified one or more received student applications that met the posted qualifications to a jobs center, and provide an appointment schedule for interviews offered by an interested posting entity to a qualified student. The method also includes allowing a teacher, principal, or administrator, through a classroom viewing application, to provide a log-in interface for an outside entity to view a classroom in session, verify log-in credentials of the outside entity, confirm authorization of the outside entity to view the classroom in session, and provide a viewing of the classroom in session after the verification and confirmation. The method also includes allowing an instructor, through a student evaluation application, to provide a completed evaluation of a student by the instructor, schedule an appointment with the student to discuss the completed evaluation, and receive responses from the evaluated student. The method also includes allowing a student, through a teacher evaluation application, to provide a completed evaluation of a teacher by the student, schedule an appointment with the student to discuss the completed evaluation, and receive responses from the evaluated teacher.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A-1B are block diagrams illustrating an educational system circuitry according to an embodiment;

FIG. 2 is a block diagram illustrating an exemplary electronic device according to an embodiment;

FIG. 3 is a block diagram illustrating a hardware description of a computing device according to an embodiment;

FIG. 4 is a block diagram illustrating a data processing system according to an embodiment;

FIG. 5 is a block diagram illustrating an implementation of a CPU according to an embodiment; and

FIGS. 6A-6G are exemplary algorithmic flowcharts for a method of establishing an educational system according to an embodiment.

### DETAILED DESCRIPTION OF THE EMBODIMENTS

Embodiments herein describe an inter-connected educational system including, but not limited to multiple applications for posting, evaluations, educational assistance, libraries, jobs, databases, blogs, and platforms. The multiple applications include features for student, parent, and instructor relationships. The inter-connected educational system can be used in various educational and training environments. For example, the inter-connected educational system can be used in “non-school” environments, such as a workplace environment in which education and/or training is provided to workers, employees, volunteers, and/or contractors.

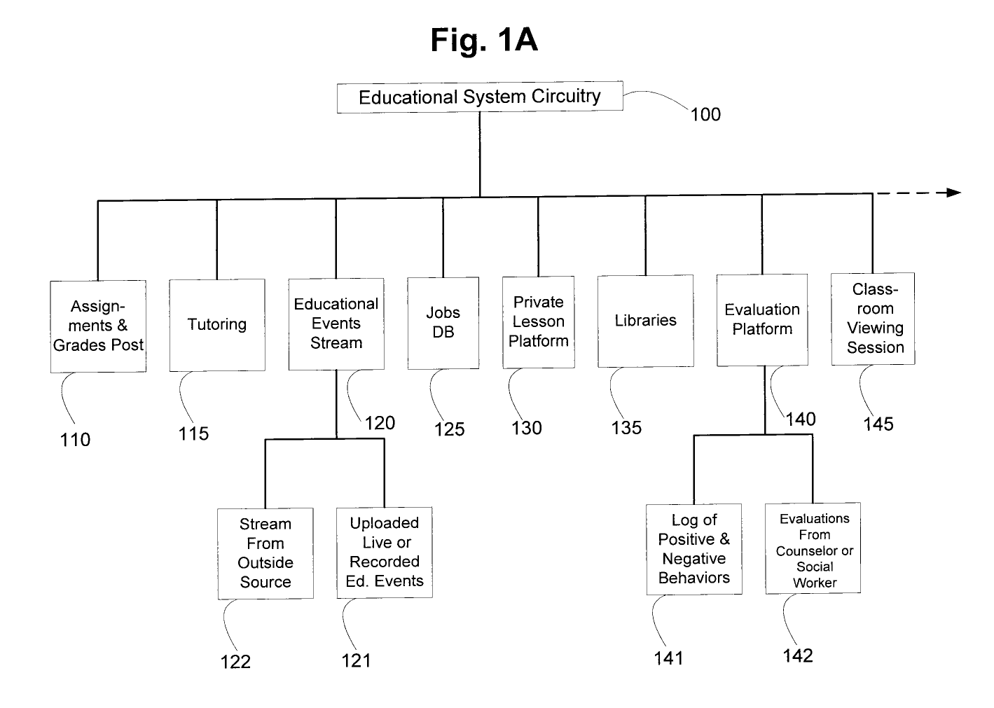

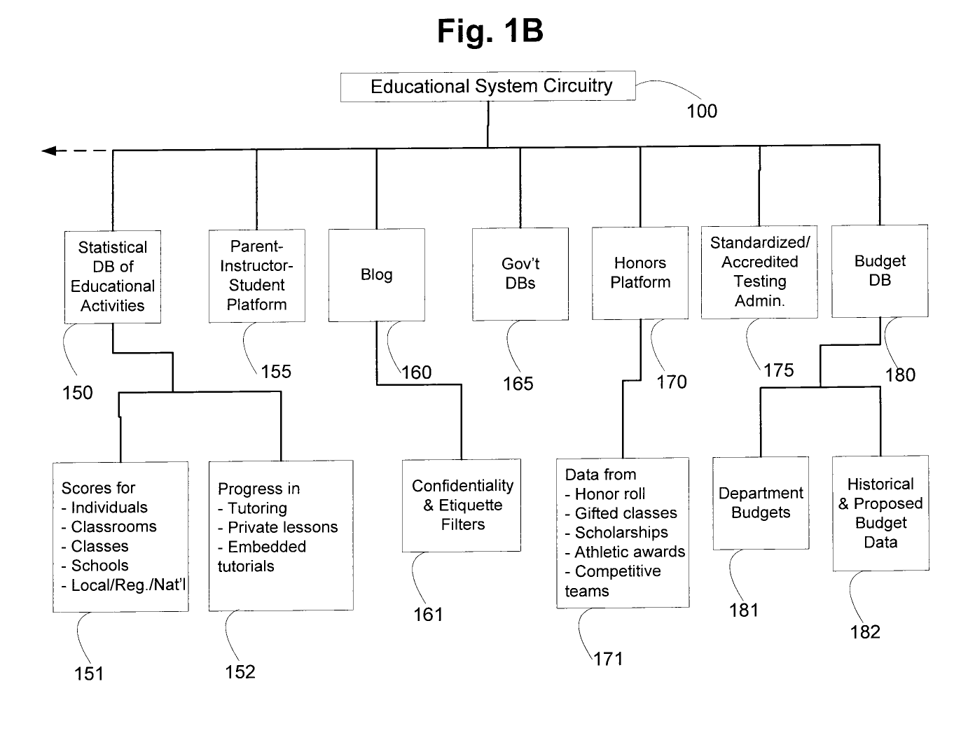

FIG. 1A is a block diagram illustrating an educational system circuitry 100. Multiple applications are branched together through one or more control and data connections. The multiple applications can be controlled by one or more processors of the educational system circuitry 100 through the one or more control and data connections, In another embodiment, each application or group of applications can be directly controlled by its respective processor, which can be interconnected to the educational system circuitry 100 through the one or more control and data connections,

An assignment and grade posting application 110 provides an application in which assignments can be posted, along with instructions such as a reading assignment and the due date. Graded assignments, projects, and tests can also be posted within the assignment and grade posting application 110. In addition to a grade or score, the assignments, projects, and tests can include embedded tutorials and/or links that are pertinent to a particular area of the completed assignment, project, or test that appeared to be weak or inaccurate. This provides immediate assistance to the student to strengthen or correct the particular area.

A tutoring application 115 provides multiple applications in which tutoring services can be offered, referred, or requested. Individual appointments can be scheduled for a tutoring session. The actual tutoring session can also be conducted via the tutoring application 115, such as via video conferencing. Video conferencing can be executed through a local or wide area network, or through the Internet. In addition, a tutoring session is intended to include one or more persons per session, and could include groups of individuals in one or more locations.

An educational events stream application 120 includes live or recorded events streamed to or from the educational system circuitry 100. An educational event includes, but is not limited to a classroom session, a guest lecture session, a musical or theatrical production, an athletic event, an awards ceremony, or a graduation ceremony, for example. The educational event can be uploaded to another location or another educational system circuitry via an uploaded educational event application 121. The uploaded event can be live or recorded. Other live or recorded educational events from other sources can also be streamed or downloaded, respectively in an outside source stream application 122.

A jobs database application 125 includes data from posted jobs for users of the educational system circuitry. A job posting can include general information pertaining to the job, including but not limited to the job title, salary or wage, hours worked, duration, qualifications, location, and a description of job duties. The jobs database application 125 could include postings for jobs wanted and jobs to offer. In addition, a link can be provided from the jobs database application 125 to a local job counseling center, either within the educational system circuitry 100 or to an outside job counseling center, such as a city or county job counseling center.

A private lesson platform application 130 can provide an interface for a student and an instructor for specialized or enhanced instruction. Private lessons can be scheduled and conducted via the private lesson application 130. A private lesson is intended to include one or more persons per session, and could include groups of individuals in one or more locations. In addition, private lessons can be executed via video conferencing through a local or wide area network, or through the Internet.

A libraries application 135 provides an interface for a library within the educational system circuitry 100, which can include a complete electronic card catalog of the library holdings, as well as a complete record of some of the library holdings. The libraries application 135 can also include a link to other libraries, such as sister libraries of other university libraries or other branch company libraries. It could also include links to one or more local libraries, such as city or county libraries. Links could also include specialty libraries, such as an electronic association library. Other types of libraries intended for the dissemination of their holdings to users for free or for a fee are contemplated by embodiments described herein.

An evaluation platform application 140 provides an interface for individual or group evaluations. The evaluation platform application 140 includes an evaluation application for both the student and the instructor. The evaluation platform application 140 also includes a log of positive and negative behaviors application 141. In a private or public classroom environment, the behavior log could include a student's behavior while listening to instructions, behavior towards other students, attentiveness while working, and social behavior during recess, lunchtime, or other class activities. In a workplace environment, the behavior log could include employee behaviors or attitudes towards listening to instructions, carrying out instructions, interactions with other co-workers, attention to detail, management of workload, independence, and initiative. The evaluation platform application 140 can also include evaluations from a counselor or social worker application 142. This could include evaluations or input of a medical nature, especially in an instance of a mental or psychological disorder or a learning handicap.

The evaluation platform application 140 can include a collection of data from evaluations received from one or more sources, as well as reminders for regular evaluations to be completed. The evaluation platform application 140 includes evaluations of an instructor by a student or a supervisor by a worker, with reference to the two example environments discussed above. The evaluation platform application 140 can also include confidentiality measures and anonymity parameters according to pre-established criteria of the evaluation platform application 140.

A classroom viewing session application 145 provides an interface for parents or other viewers to observe a live classroom session from another location. This would provide the advantage of observing student behavior in the absence of direct supervision anonymously. The classroom viewing session could provide information for parents, supervisors, government social workers or case workers, counselors, or others having an interest in the student's behavior. A security or authorization application could be included in the classroom viewing session application 145 to ensure the viewing person(s) has authorization to access the application. In another embodiment, the classroom viewing session could occur with the person or people having knowledge of being viewed, including but not limited to a thesis presentation, an accreditation or school-related hearing, an evaluation by person(s) not physically present, and a performance review.

FIG. 1B is an extension of FIG. 1A of the educational system circuitry 100. A statistical database 150 includes data collected, processed, and provided for a wide range of educational activities. A scores application 151 includes data for scores from individuals, classrooms, classes, schools, and from local, regional, and national collective regions. The scores application 151 can include standardized scores, such as accreditation test scores, city or state test scores, college preparatory test scores, advanced placement test scores, or other test scores in which a broad audience participates in the same testing. Rankings from standardized test scores can also be included in the scores application 151. Non-standardized test scores can also be included, as well as non-test scores, such as homework assignments or projects.

A progress application 152 can include a variety of documented progress or markers to indicate the amount and type of progress made towards a particular endeavor. Progress markers can include one or more rankings of various areas pertaining to the particular activity being measured. Progress can be monitored for a variety of activities, such as tutoring, private lessons, and embedded tutorials, for example. As an example, given for illustrative purposes only, the progress of private musical instrument lessons can be measured over a period of time, such as six months. The measured areas can include improvements made in reading music, accuracy in playing the correct notes, incorporation of other musical notations (e.g. changes in volume, speed, and punctuation of notes), flow and stamina from the beginning of a musical piece to the end, and good form in terms of holding or playing the instrument, posture, and embouchure. Another example, given for illustrative purposes only, is for athletic conditioning. Measured areas of progress can include stretching and muscle-building exercises, specific workouts geared to the particular sport, weight lifting, diet, and skills repetition. Measurements of timed runs, number of “misses” (depending upon the sport), increases in the weight lifted or the number of repetitions for weight lifting, and achieving a desired body weight or muscular density can be used as objective markers over a set period of time, in addition to subjective evaluations of progress.

The progress application 152 can also include associated surveys that are presented to a user or an instructor to help measure the amount of progress or success of a program. The surveys can be geared towards improvements to an existing area of the activity, or suggestions for adding or removing a specific item or items. In addition, an electronic suggestion box can be included for students and instructors, as well as others not directly involved in a particular instruction. A completed tutorial can be followed up with a survey for the user, the results of which can be evaluated in combination with the completed results of the tutorial.

A parent-instructor-student platform application 155 can include a 3-way (or more) video conferencing implementation. One or more parts of the video conferencing can be video-recorded for future reference. It can also include a previous recording of one party and a live conference of the remaining parties. In addition, various reports, evaluations, agenda, or forms can be issued prior to the actual conference, which can be discussed during the conference. The reports, evaluations, agenda, or forms can be made of record for the particular student being evaluated. An alternative embodiment includes an instructor-student platform application for educational system circuitry 100 for adult education.

A social networking application 160 can include a blog or an open forum in which students, instructors, parents, or other interested and concerned individuals can post items pertinent to the educational system circuitry 100. Various filters can be implemented, such as a confidentiality and etiquette filter application 161. This can help to ensure that confidential information is not made public, and to also ensure that posts containing any remarks of a discriminatory, defamatory, or derogatory nature are not posted.

One or more government databases 165 can include data from local, regional, or national databases. Government databases 165 include, but are not limited to criminal, juvenile, motor vehicles, family, and medical databases. One or more of the government databases 165 can include links to the official databases with appropriate security measures and filters.

An honors platform application 170 can include various mechanisms in which students can be recognized for a particular achievement. The various mechanisms can be in the form of test results or other achievement marks, and can also include publications from sources outside of the educational system circuitry 100, such as a local newspaper. Data application 171 can include a variety of results pertaining to the honors platform application 170. Data includes, but is not limited to honor roll names and grade point averages, gifted class enrollees, scholarship recipients, athletic award recipients, and various competitive team members, such as a math team, debate team, chess team, etc.

A standardized and accredited testing administration application 175 can include mechanisms or modules for administration of the testing within the educational system circuitry 100. Official parameters and requirements for administering various standardized and accredited tests can be established and approved within the educational system circuitry 100, such as the requirements for administering a Scholastic Aptitude Test (SAT) or other college or graduate level standardized test. The official parameters and requirements can include, but are not limited to testing location arrangements or layout, monitoring person requirements, verbal and written instructions, allotted time for test-taking, possession by test-takers of written materials or electronic devices, handling of completed tests, and procedures for any violations. Other measures that are specific to the type of standardized or accredited testing to be administered are contemplated by embodiments described herein.

A budget database 180 can include a myriad of data pertaining to individual budgets and an overall budget of the educational system circuitry 100. A department budget database 181 can include data for individual sections of an educational system, such as structural buildings, grounds, mechanical facilities, utilities, teachers, non-teaching employees, busing, libraries, consumable goods, etc. The department budget database 181 can also be categorized by academic subject categories, such as language arts, history, mathematics, science, music, art and theater, physical education, etc.

Budget database 180 can also include an historical and proposed budget database 182. Data from previous budgets can be used as a comparison or guide in determining a proposed budget. The data can also be used as an evaluation tool in determining the effectiveness of an existing program and whether to continue, revise, or cancel the particular program. Historical and proposed budget database 182 can also be used to compare to other educational systems.

Educational system circuitry 100 described above and its associated programming are used in conjunction with electronic devices and computerized systems described below to execute the functions and modules of the various databases, platforms, and applications described above. The resulting circuitry, programming, and hardware are incorporated into a special purpose computing device by which the functions are executed and the advantages of embodiments described herein are achieved.

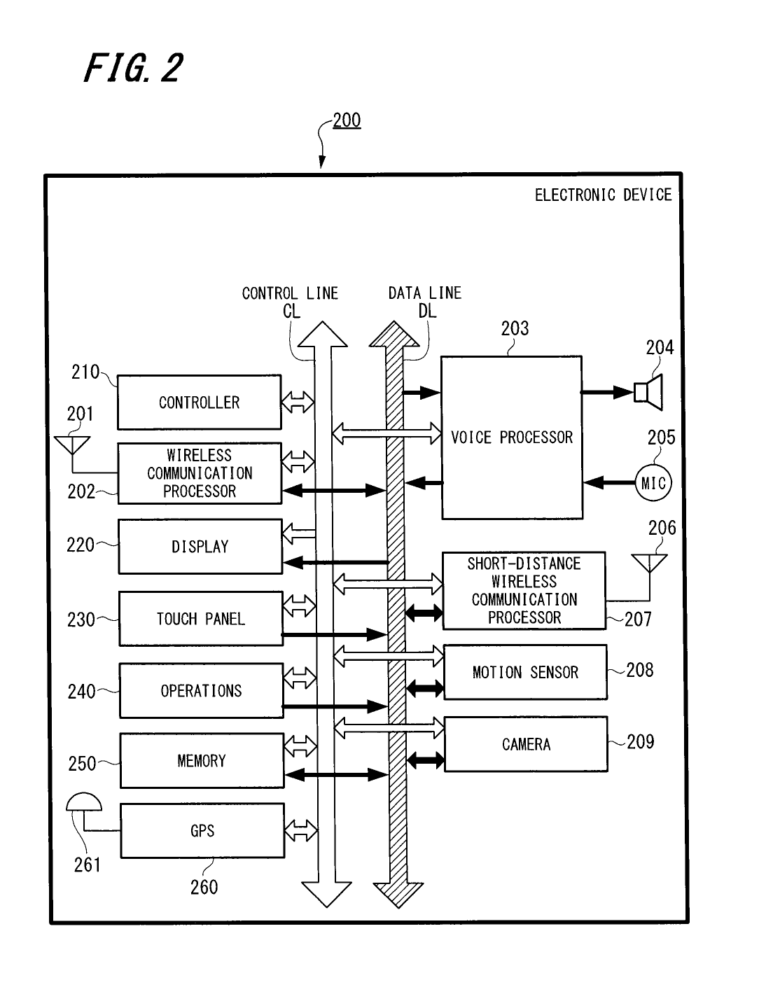

FIG. 2 is a block diagram illustrating an exemplary electronic device used in accordance with certain embodiments of the present disclosure. In certain embodiments, electronic device 200 can be a smartphone, a laptop, a tablet, a server, an e-reader, a camera, a navigation device, etc. The exemplary electronic device 200 of FIG. 2 includes a controller 210 and a wireless communication processor 202 connected to an antenna 201. A speaker 204 and a microphone 205 are connected to a voice processor 203.

The controller 210 can include one or more Central Processing Units (CPUs), and can control each element in the electronic device 200 to perform functions related to communication control, audio signal processing, control for the audio signal processing, still and moving image processing and control, and other kinds of signal processing. The controller 210 can perform these functions by executing instructions stored in a memory 250. Alternatively or in addition to the local storage of the memory 250, the functions can be executed using instructions stored on an external device accessed on a network or on a non-transitory computer readable medium.

The memory 250 includes but is not limited to Read Only Memory (ROM), Random Access Memory (RAM), or a memory array including a combination of volatile and non-volatile memory units. The memory 250 can be utilized as working memory by the controller 210 while executing the processes and algorithms of the present disclosure. Additionally, the memory 250 can be used for long-term storage, e.g., of image data and information related thereto.

The electronic device 200 includes a control line CL and data line DL as internal communication bus lines. Control data to/from the controller 210 can be transmitted through the control line CL. The data line DL can be used for transmission of voice data, display data, etc. One or more control lines CL and one or more data lines DL include educational system circuitry 100 and associated one or more control and data connections, as illustrated in FIGS. 1A and 1B.

The antenna 201 transmits/receives electromagnetic wave signals between base stations for performing radio-based communication, such as the various forms of cellular telephone communication. The wireless communication processor 202 controls the communication performed between the electronic device 200 and other external devices via the antenna 201. For example, the wireless communication processor 202 can control communication between base stations for cellular phone communication.

The speaker 204 emits an audio signal corresponding to audio data supplied from the voice processor 203. The microphone 205 detects surrounding audio and converts the detected audio into an audio signal. The audio signal can then be output to the voice processor 203 for further processing. The voice processor 203 demodulates and/or decodes the audio data read from the memory 250 or audio data received by the wireless communication processor 202 and/or a short-distance wireless communication processor 207. Additionally, the voice processor 203 can decode audio signals obtained by the microphone 205.

The exemplary electronic device 200 can also include a display 220, a touch panel 230, an operations key 240, and a short-distance communication processor 207 connected to an antenna 206. The display 220 can be a Liquid Crystal Display (LCD), an organic electroluminescence display panel, or another display screen technology. In addition to displaying still and moving image data, the display 220 can display operational inputs, such as numbers or icons which can be used for control of the electronic device 200. The display 220 can additionally display a GUI for a user to control aspects of the electronic device 200 and/or other devices. Further, the display 220 can display characters and images received by the electronic device 200 and/or stored in the memory 250 or accessed from an external device on a network. For example, the electronic device 200 can access a network such as the Internet and display text and/or images transmitted from a Web server.

The touch panel 230 can include a physical touch panel display screen and a touch panel driver. The touch panel 230 can include one or more touch sensors for detecting an input operation on an operation surface of the touch panel display screen. The touch panel 230 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus can include a conductive material at least at the tip of the stylus such that the sensors included in the touch panel 230 can detect when the stylus approaches/contacts the operation surface of the touch panel display (similar to the case in which a finger is used for the touch operation).

In certain aspects of the present disclosure, the touch panel 230 can be disposed adjacent to the display 220 (e.g., laminated) or can be formed integrally with the display 220. For simplicity, the present disclosure assumes the touch panel 230 is formed integrally with the display 220 and therefore, examples discussed herein can describe touch operations being performed on the surface of the display 220 rather than the touch panel 230. However, the skilled artisan will appreciate that this is not limiting.

For simplicity, the present disclosure assumes the touch panel 230 is a capacitance-type touch panel technology. However, it should be appreciated that aspects of the present disclosure can easily be applied to other touch panel types (e.g., resistance-type touch panels) with alternate structures. In certain aspects of the present disclosure, the touch panel 230 can include transparent electrode touch sensors arranged in the X-Y direction on the surface of transparent sensor glass.

The touch panel driver can be included in the touch panel 230 for control processing related to the touch panel 230, such as scanning control. For example, the touch panel driver can scan each sensor in an electrostatic capacitance transparent electrode pattern in the X-direction and Y-direction and detect the electrostatic capacitance value of each sensor to determine when a touch operation is performed. The touch panel driver can output a coordinate and corresponding electrostatic capacitance value for each sensor. The touch panel driver can also output a sensor identifier that can be mapped to a coordinate on the touch panel display screen. Additionally, the touch panel driver and touch panel sensors can detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. Signals can be transmitted by the touch panel driver, e.g. in response to a detection of a touch operation, in response to a query from another element based on timed data exchange, etc.

The touch panel 230 and the display 220 can be surrounded by a protective casing, which can also enclose the other elements included in the electronic device 200. In certain embodiments, a position of the user's fingers on the protective casing (but not directly on the surface of the display 220) can be detected by the touch panel 230 sensors. Accordingly, the controller 210 can perform display control processing described herein based on the detected position of the user's fingers gripping the casing. For example, an element in an interface can be moved to a new location within the interface (e.g., closer to one or more of the fingers) based on the detected finger position.

Further, in certain embodiments, the controller 210 can be configured to detect which hand is holding the electronic device 200, based on the detected finger position. For example, the touch panel 230 sensors can detect a plurality of fingers on the left side of the electronic device 200 (e.g., on an edge of the display 220 or on the protective casing), and detect a single finger on the right side of the electronic device 200. In this exemplary scenario, the controller 210 can determine that the user is holding the electronic device 200 with his/her right hand because the detected grip pattern corresponds to an expected pattern when the electronic device 200 is held only with the right hand.

The operation key 240 can include one or more buttons or similar external control elements, which can generate an operation signal based on a detected input by the user. In addition to outputs from the touch panel 230, these operation signals can be supplied to the controller 210 for performing related processing and control. In certain aspects of the present disclosure, the processing and/or functions associated with external buttons and the like can be performed by the controller 210 in response to an input operation on the touch panel 230 display screen rather than the external button, key, etc. In this way, external buttons on the electronic device 200 can be eliminated in lieu of performing inputs via touch operations, thereby improving water-tightness.

The antenna 206 can transmit/receive electromagnetic wave signals to/from other external apparatuses, and the short-distance wireless communication processor 207 can control the wireless communication performed between the other external apparatuses. Bluetooth, IEEE 802.11, and near-field communication (NFC) are non-limiting examples of wireless communication protocols that can be used for inter-device communication via the short-distance wireless communication processor 207.

The electronic device 200 can include a motion sensor 208. The motion sensor 208 can detect features of motion (i.e., one or more movements) of the electronic device 200. For example, the motion sensor 208 can include an accelerometer to detect acceleration, a gyroscope to detect angular velocity, a geomagnetic sensor to detect direction, a geo-location sensor to detect location, etc., or a combination thereof to detect motion of the electronic device 200. In certain embodiments, the motion sensor 208 can generate a detection signal that includes data representing the detected motion. For example, the motion sensor 208 can determine a number of distinct movements in a motion (e.g., from start of the series of movements to the stop, within a predetermined time interval, etc.), a number of physical shocks on the electronic device 200 (e.g., a jarring, hitting, etc., of the electronic device 200), a speed and/or acceleration of the motion (instantaneous and/or temporal), or other motion features. The detected motion features can be included in the generated detection signal. The detection signal can be transmitted, e.g., to the controller 210, whereby further processing can be performed based on data included in the detection signal. The motion sensor 208 can work in conjunction with a Global Positioning System (GPS) 260. The GPS 260 detects the present position of the electronic device 200. The information of the present position detected by the GPS 260 is transmitted to the controller 210. An antenna 261 is connected to the GPS 260 for receiving and transmitting signals to and from a GPS satellite.

Electronic device 200 can include a camera 209, which includes a lens and shutter for capturing photographs of the surroundings around the electronic device 200. In an embodiment, the camera 209 captures surroundings of an opposite side of the electronic device 200 from the user. The images of the captured photographs can be displayed on the display panel 220. A memory saves the captured photographs. The memory can reside within the camera 209 or it can be part of the memory 250. The camera 209 can be a separate feature attached to the electronic device 200 or it can be a built-in camera feature.

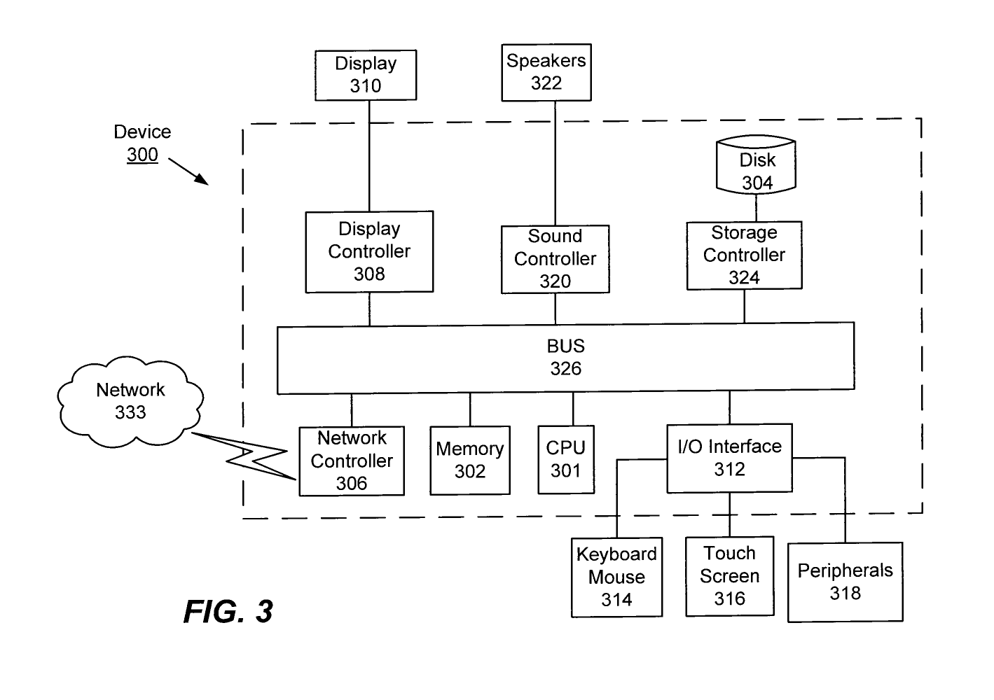

Next, a hardware description of a computing device 300 according to exemplary embodiments is described with reference to FIG. 3. Certain features described above with reference to electronic device 200 of FIG. 2 can be included in the computing device 300 described below. Exemplary embodiments described herein can be implemented on either electronic device 200 or computing device 300.

In FIG. 3, the computing device 300 includes a CPU 301 which performs the processes described above and herein after. The process data and instructions can be stored in memory 302. These processes and instructions can also be stored on a storage medium disk 304 such as a hard drive (HDD) or portable storage medium or can be stored remotely. Further, the claimed features are not limited by the form of the computer-readable media on which the instructions of the process are stored. For example, the instructions can be stored on CDs, DVDs, in FLASH memory, RAM, ROM, PROM, EPROM, EEPROM, hard disk or any other information processing device with which the computing device 300 communicates, such as a server or computer.

Further, the claimed features can be provided as a utility application, background daemon, or component of an operating system, or combination thereof, executing in conjunction with CPU 301 and an operating system such as Microsoft Windows 7, UNIX, Solaris, LINUX, Apple MAC-OS and other systems known to those skilled in the art.

The hardware elements in order to achieve the computing device 300 can be realized by various circuitry elements, known to those skilled in the art. For example, CPU 301 can be a Xenon or Core processor from Intel of America or an Opteron processor from AMD of America, or can be other processor types that would be recognized by one of ordinary skill in the art. Alternatively, the CPU 301 can be implemented on an FPGA, ASIC, PLD or using discrete logic circuits, as one of ordinary skill in the art would recognize. Further, CPU 301 can be implemented as multiple processors cooperatively working in parallel to perform the instructions of the inventive processes described above and below.

The computing device 300 in FIG. 3 also includes a network controller 306, such as an Intel Ethernet PRO network interface card from Intel Corporation of America, for interfacing with network 333. As can be appreciated, the network 333 can be a public network, such as the Internet, or a private network such as an LAN or WAN network, or any combination thereof and can also include PSTN or ISDN sub-networks. The network 333 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device 300 further includes a display controller 308, such as a NVIDIA GeForce GTX or Quadro graphics adaptor from NVIDIA Corporation of America for interfacing with display 310, such as a Hewlett Packard HPL2445w LCD monitor. A general purpose I/O interface 312 interfaces with a keyboard and/or mouse 314 as well as a touch screen panel 316 on or separate from display 310. Touch screen panel 316 includes features described above with reference to touch panel 230 of FIG. 2. General purpose I/O interface 312 also connects to a variety of peripherals 318 including printers and scanners, such as an OfficeJet or DeskJet from Hewlett Packard.

A sound controller 320 is also provided in the computing device 300, such as Sound Blaster X-Fi Titanium from Creative, to interface with speakers/microphone 322 thereby providing sounds and/or music.

The general purpose storage controller 324 connects the storage medium disk 304 with communication bus 326, which can be an ISA, EISA, VESA, PCI, or similar, for interconnecting all of the components of the computing device 300. Communication bus 326 includes the educational system circuitry 100, illustrated in FIGS. 1A and 1B. A description of the general features and functionality of the display 310, keyboard and/or mouse 314, as well as the display controller 308, storage controller 324, network controller 306, sound controller 320, and general purpose I/O interface 312 is omitted herein for brevity as these features are known.

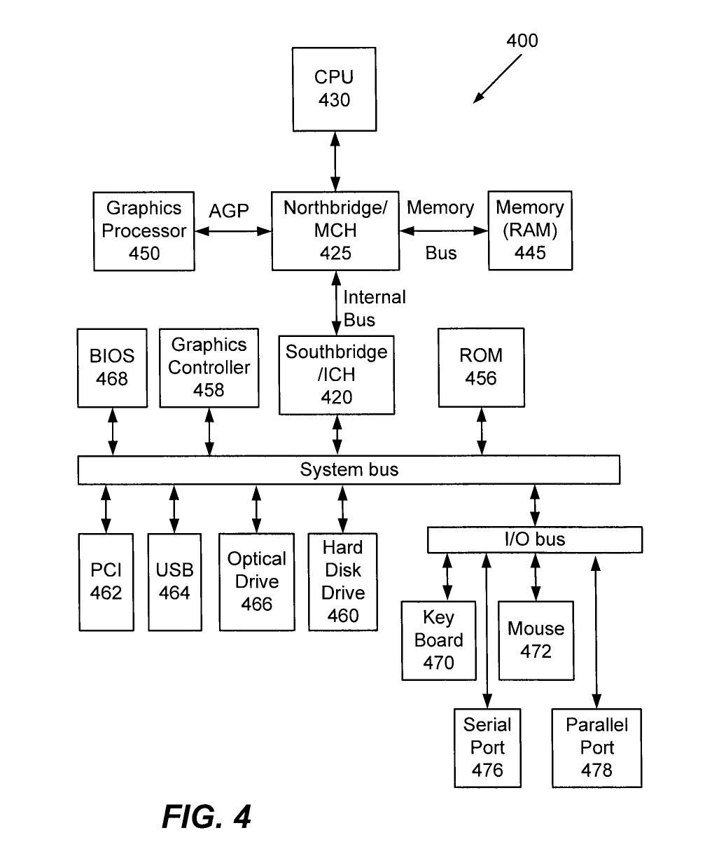

The exemplary circuit elements described in the context of the present disclosure can be replaced with other elements and structured differently than the examples provided herein. Moreover, circuitry configured to perform features described herein can be implemented in multiple circuit units (e.g., chips), or the features can be combined in circuitry on a single chipset, as shown on FIG. 4. The chipset of FIG. 4 can be implemented in conjunction with either electronic device 200 or computing device 300 described above with reference to FIGS. 2 and 3, respectively.

FIG. 4 shows a schematic diagram of a data processing system, according to certain embodiments, for performing menu navigation, as described above. The data processing system is an example of a computer in which code or instructions implementing the processes of the illustrative embodiments can be located.

In FIG. 4, data processing system 400 employs a application architecture including a north bridge and memory controller application (NB/MCH) 425 and a south bridge and input/output (I/O) controller application (SB/ICH) 420. The central processing unit (CPU) 430 is connected to NB/MCH 425. The NB/MCH 425 also connects to the memory 445 via a memory bus, and connects to the graphics processor 450 via an accelerated graphics port (AGP). The NB/MCH 425 also connects to the SB/ICH 420 via an internal bus (e.g., a unified media interface or a direct media interface). The CPU 430 can contain one or more processors and even can be implemented using one or more heterogeneous processor systems.

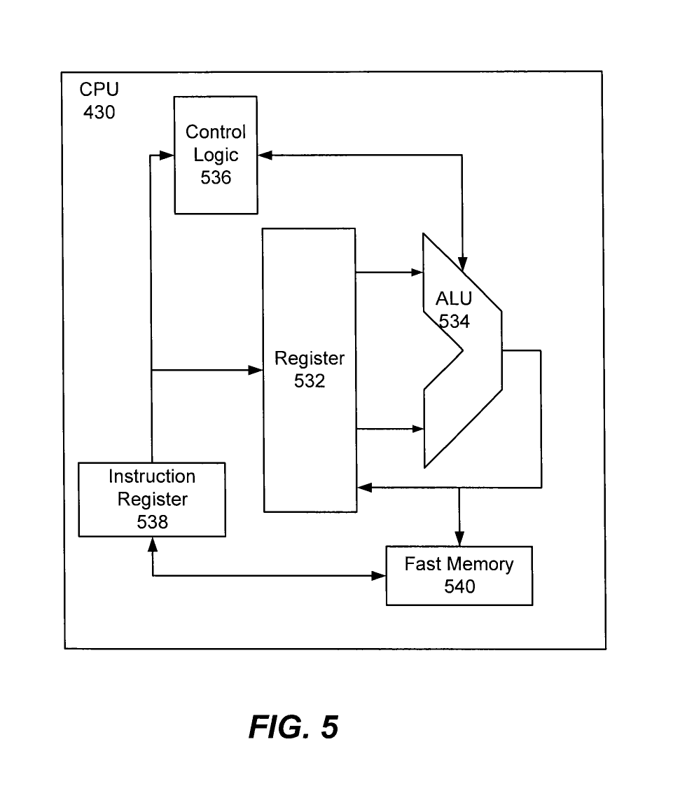

For example, FIG. 5 shows one implementation of CPU 430. In one implementation, an instruction register 538 retrieves instructions from a fast memory 540. At least part of these instructions are fetched from an instruction register 538 by a control logic 536 and interpreted according to the instruction set architecture of the CPU 430. Part of the instructions can also be directed to a register 532. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using an arithmetic logic unit (ALU) 534 that loads values from the register 532 and performs logical and mathematical operations on the loaded values according to the instructions. The results from these operations can be fed back into the register 532 and/or stored in a fast memory 540. According to certain implementations, the instruction set architecture of the CPU 430 can use a reduced instruction set architecture, a complex instruction set architecture, a vector processor architecture, or a very large instruction word architecture. Furthermore, the CPU 430 can be based on the Von Neuman model or the Harvard model. The CPU 430 can be a digital signal processor, an FPGA, an ASIC, a PLA, a PLD, or a CPLD. Further, the CPU 430 can be an x86 processor by Intel or by AMD; an ARM processor; a Power architecture processor by, e.g., IBM; a SPARC architecture processor by Sun Microsystems or by Oracle; or other known CPU architectures.

Referring again to FIG. 4, the data processing system 400 can include the SB/ICH 420 being coupled through a system bus to an I/O Bus, a read only memory (ROM) 456, universal serial bus (USB) port 464, a flash binary input/output system (BIOS) 468, and a graphics controller 458. PCI/PCIe devices can also be coupled to SB/ICH 420 through a PCI bus 462.

The PCI devices can include, for example, Ethernet adapters, add-in cards, and PC cards for notebook computers. The Hard disk drive 460 and CD-ROM 466 can use, for example, an integrated drive electronics (IDE) or serial advanced technology attachment (SATA) interface. In one implementation the I/O bus can include a super I/O (SIO) device.

Further, the hard disk drive (HDD) 460 and optical drive 466 can also be coupled to the SB/ICH 420 through a system bus. In one implementation, a keyboard 470, a mouse 472, a parallel port 478, and a serial port 476 can be connected to the system bus through the I/O bus. Other peripherals and devices can be connected to the SB/ICH 420 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein can also be executed by various distributed components of a system. For example, one or more processors can execute these system functions, wherein the processors are distributed across multiple components communicating in a network. The distributed components can include one or more client and server machines, which can share processing, such as a cloud computing system, in addition to various human interface and communication devices (e.g., display monitors, smart phones, tablets, personal digital assistants (PDAs)). The network can be a private network, such as a LAN or WAN, or can be a public network, such as the Internet. Input to the system can be received via direct user input and received remotely either in real-time or as a batch process. Additionally, some implementations can be performed on modules or hardware not identical to those described. Accordingly, other implementations are within the scope that can be claimed.

The educational system circuitry 100 described above interconnects associated programming with one or more hardware devices described above to provide an improved computerized system. Educational system circuitry 100 connects multiple computing applications together for efficient navigation through one system. Links to outside sources and networks directly connect to one or more applications of the educational system circuitry 100. Database indexes of the educational system circuitry 100 are used to process incoming inputted data with existing data to provide fresh and efficient output search results, via one or more backend search engines. The combination of on-the-fly updated databases, streaming application modules, direct links to outside source databases and platforms, and live interconnected sessions provide a complete and efficient computerized system over previous segregated and incompatible systems.

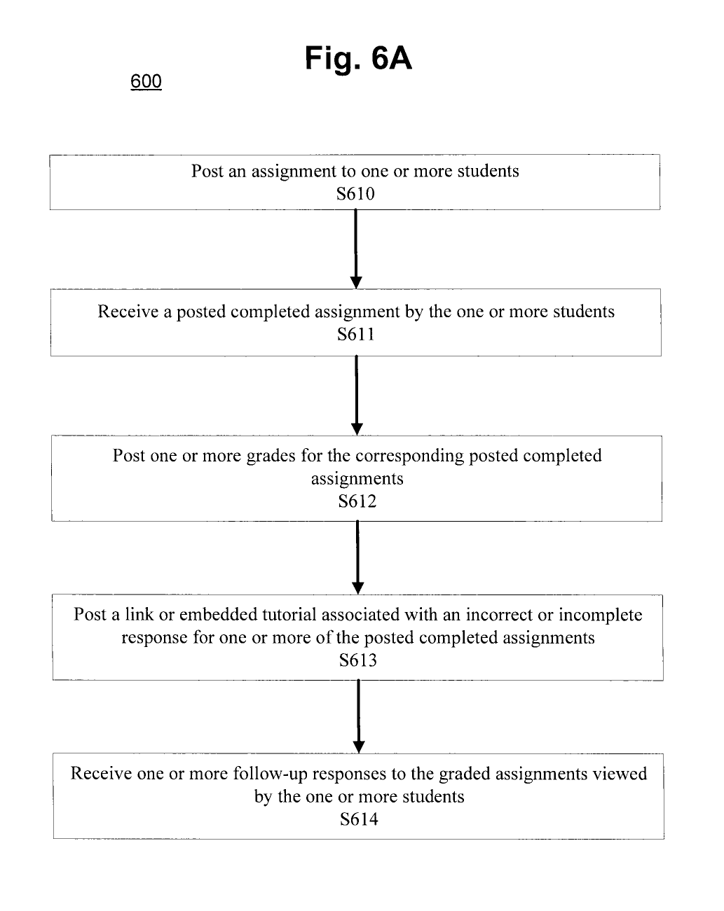

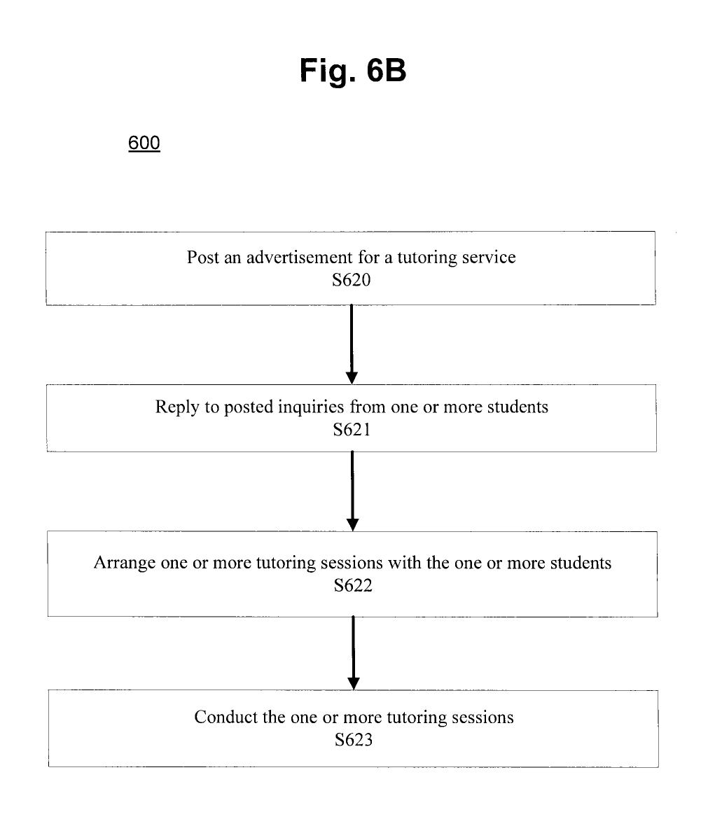

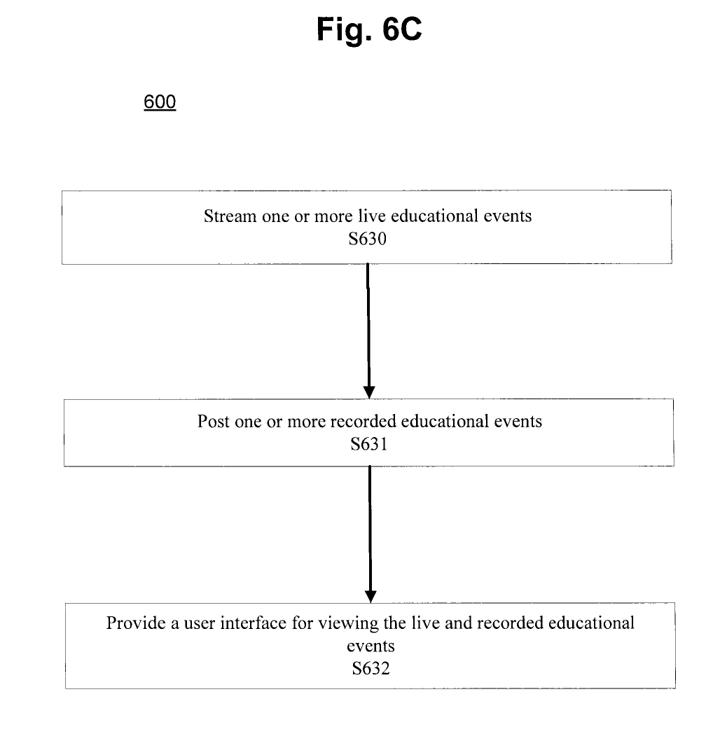

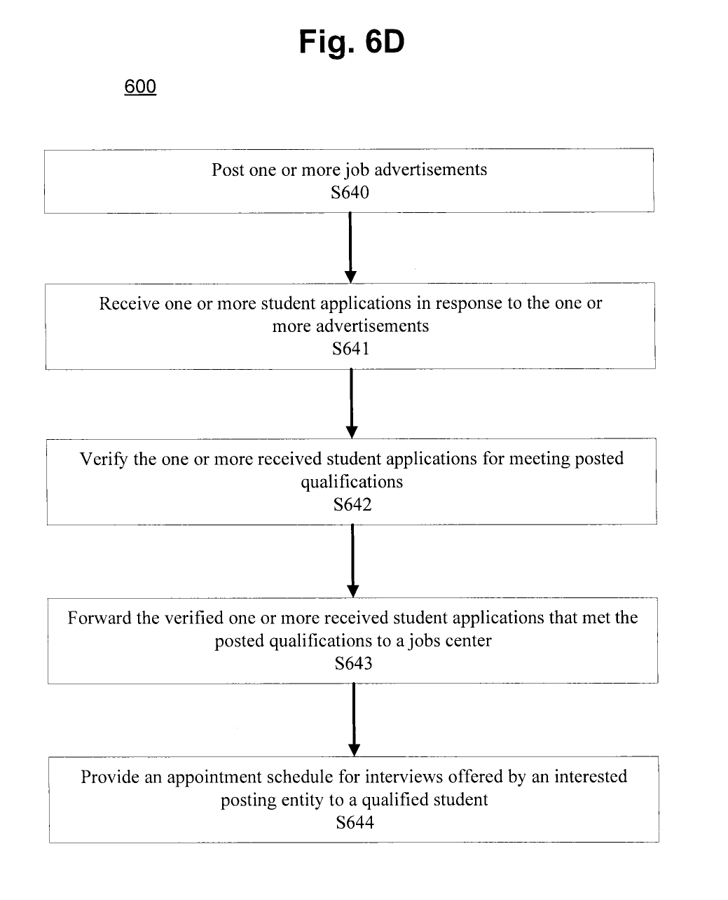

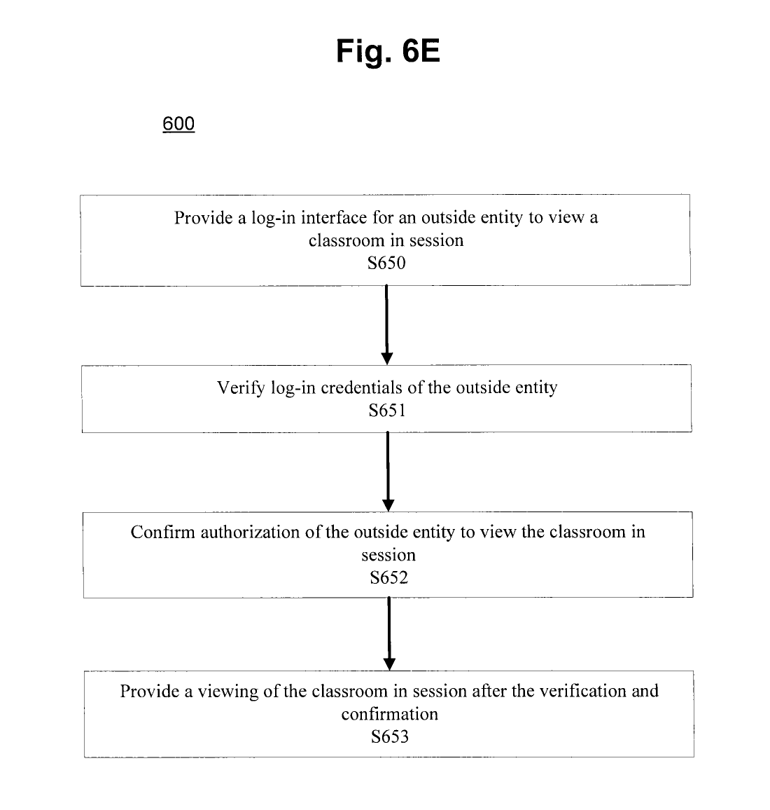

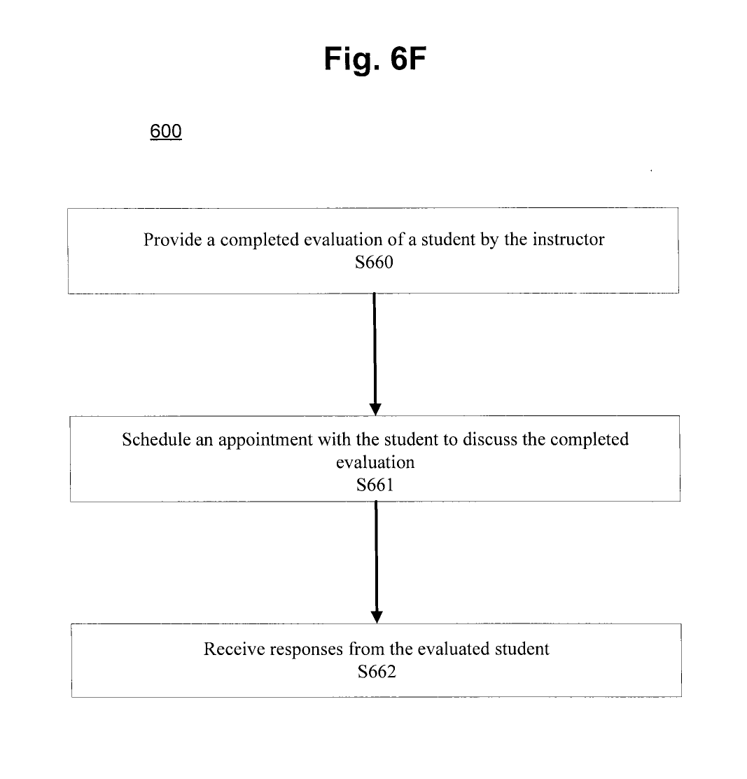

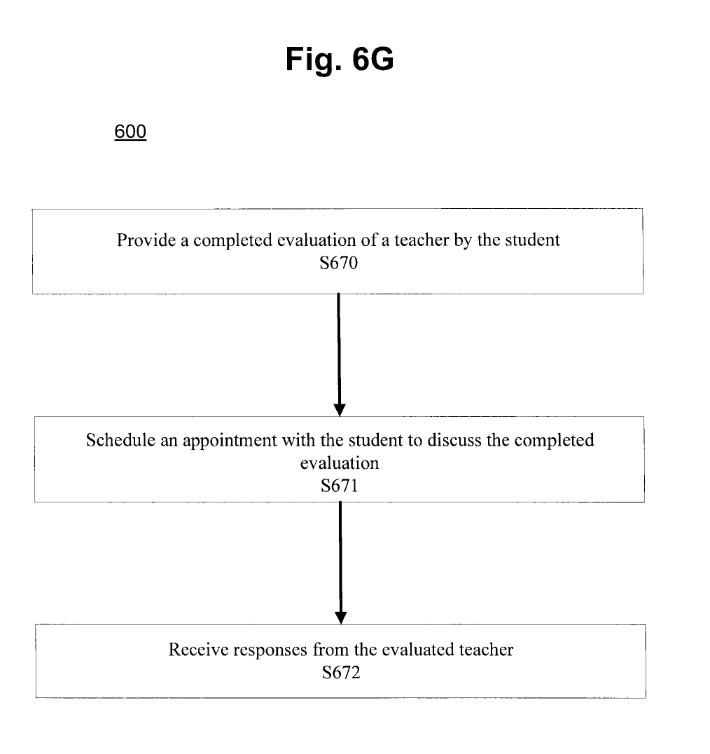

FIGS. 6A-6G illustrate exemplary algorithmic flowcharts for a method 600 of establishing an educational system according to an aspect of the present disclosure. Method 600 includes programmable computer-executable instructions, that when used in combination with the above-described educational system circuitry 100 and the above-described hardware devices, carry out the steps of method 600. The hardware description above, exemplified by any one of the structural examples illustrated in FIG. 2, 3, or 4 constitutes or includes specialized corresponding structure that is programmed or configured to perform the algorithms illustrated in FIGS. 6A-6G. For example, the algorithm illustrated in FIGS. 6A-6G can be completely performed by the single device illustrated in FIG. 2 or FIG. 3, or the chipset illustrated in FIG. 4. The algorithms can also be completely performed in a shared manner distributed over the circuitry of any plurality of devices in a cloud computing system.

In FIG. 6A, a first algorithm for method 600 includes allowing a teacher, through an assignment and grade posting application, to perform the following steps. In step S610, an assignment to one or more students is posted. In step S611, a posted completed assignment by the one or more students is received. In step S612, one or more grades for the corresponding posted completed assignments are posted. In step S613, a link or embedded tutorial associated with an incorrect or incomplete response for one or more of the posted completed assignments is posted. In step S614, one or more follow-up responses to the graded assignments viewed by the one or more students are received.

In FIG. 6B, a second algorithm for method 600 includes allowing an instructor, through a tutoring application, to perform the following steps. In step S620, an advertisement for a tutoring service is posted. In step S621, a reply is made in response to posted inquiries from one or more students. In step S622, one or more tutoring sessions with the one or more students is arranged. In step S623, the one or more tutoring sessions are conducted.

In FIG. 6C, a third algorithm for method 600 includes allowing a teacher, principal, or administrator, via a web server, to perform the following steps. In step S630, one or more live educational events are streamed. In step S631, one or more recorded educational events are posted. In step S632, a user interface for viewing the live and recorded educational events is provided.

In FIG. 6D, a fourth algorithm for method 600 includes allowing an employer, through a jobs database and application, to perform the following steps. In step S640, one or more job advertisements are posted. In step S641, one or more student applications are received in response to the one or more job advertisements. In step S642, the one or more received student applications for meeting posted qualifications are verified. In step S643, the verified one or more received student applications that met the posted qualifications are forwarded to a jobs center. In step S644, an appointment schedule for interviews offered by an interested entity is provided to a qualified student.

In FIG. 6E, a fifth algorithm for method 600 includes allowing a teacher, principal, or administrator, through a classroom viewing application, to perform the following steps. In step S650, a log-in interface is provided for an outside entity to view a classroom in session. In step S651, log-in credentials of the outside entity are verified. In step S652, authorization of the outside entity to view the classroom in session is confirmed. In step S653, a viewing of the classroom in session is provided after the verification and confirmation.

In FIG. 6F, a sixth algorithm for method 600 includes allowing an instructor, through a student evaluation application, to perform the following steps. In step S660, a completed evaluation of a student by the instructor is provided. In step S661, an appointment with the student is scheduled to discuss the completed evaluation. In step S662, responses from the evaluated student are received.

In FIG. 6G, a seventh algorithm for method 600 includes allowing a student, through a teacher evaluation application, to perform the following steps. In step S670, a completed evaluation of a teacher by the student is provided. In step S671, an appointment with the student is scheduled to discuss the completed evaluation. In step S672, responses from the evaluated teacher are received.

The foregoing discussion discloses and describes merely exemplary embodiments of educational system circuitry. As will be understood by those skilled in the art, the educational system circuitry devices, systems, and methods may be embodied in other specific forms without departing from the spirit or essential characteristics thereof. Accordingly, the disclosure herein is intended to be illustrative, but not limiting of the scope of the embodiments, as well as the claims. The disclosure, including any readily discernible variants of the teachings herein, define in part, the scope of the foregoing claim terminology.

1. An educational system, comprising:
circuitry configured to
allow a teacher, through an assignment and grade posting application, to
post an assignment to one or more students;
receive a posted completed assignment by the one or more students;
post one or more grades for the corresponding posted completed assignments;
post a link or embedded tutorial associated with an incorrect or incomplete response for one or more of the posted completed assignments;
receive one or more follow-up responses to the graded assignments viewed by the one or more students;
allow an instructor, through a tutoring application, to
post an advertisement for a tutoring service;
reply to posted inquiries from one or more students;
arrange one or more tutoring sessions with the one or more students;
conduct the one or more tutoring sessions;
allow a teacher, principal, or administrator, via a web server, to
stream one or more live educational events;
post one or more recorded educational events;
provide a user interface for viewing the live and recorded educational events;
allow an employer, through a jobs database and application, to
post one or more job advertisements;
receive one or more student applications in response to the one or more job advertisements;
verify the one or more received student applications for meeting posted qualifications;
forward the verified one or more received student applications that met the posted qualifications to a jobs center;
provide an appointment schedule for interviews offered by an interested posting entity to a qualified student;
allow a teacher, principal, or administrator, through a classroom viewing application, to
provide a log-in interface for an outside entity to view a classroom in session;
verify log-in credentials of the outside entity;
confirm authorization of the outside entity to view the classroom in session;
provide a viewing of the classroom in session after the verification and confirmation;
allow an instructor, through a student evaluation application, to
provide a completed evaluation of a student by the instructor;
schedule an appointment with the student to discuss the completed evaluation;
receive responses from the evaluated student; and
allow a student, through a teacher evaluation application, to
provide a completed evaluation of a teacher by the student;
schedule an appointment with the student to discuss the completed evaluation;
receive responses from the evaluated teacher.

2. The educational system of claim 1, wherein the circuitry is further configured to provide access interfaces for students, parents, and instructors.

3. The educational system of claim 2, wherein the circuitry is further configured to stream educational events from an outside source.

4. The educational system of claim 3, wherein the circuitry is further configured to upload live or recorded educational events to another outside entity.

5. The educational system of claim 4, wherein the circuitry is further configured to collect, process, and provide statistical data of educational activities within the educational system.

6. The educational system of claim 5, wherein the educational activities include one or more of graded assignments, test scores, and progress from continued tutoring sessions, private lessons, or embedded tutorials and links in graded assignments.

7. The educational system of claim 5, wherein the statistical data includes data from individual educational activities, classroom educational activities, class educational activities, school educational activities, and local, regional, and national educational activities.

8. The educational system of claim 5, wherein the circuitry is further configured to provide requirements and tutorials for administering standardized or accredited testing.

9. The educational system of claim 5, wherein the circuitry further includes a budget database.

10. The educational system of claim 9, wherein the budget database includes departmental budgets within the educational system.

11. The educational system of claim 9, wherein the budget database includes historical budget data and proposed budget data.

12. The educational system of claim 5, wherein the circuitry further includes an honors platform.

13. The educational system of claim 12, wherein the honors platform includes data from one or more of an honor roll achievement list, gifted class members, scholarship achievements, athletic achievement awards, and educational competitive team members.

14. The educational system of claim 5, wherein the circuitry further includes a blog for access by parents and students.

15. The educational system of claim 14, wherein the blog includes confidentiality and social etiquette parameter filters.

16. The educational system of claim 5, wherein the circuitry further includes an evaluation platform for a student, which includes a log of positive and negative classroom and schoolwork behavior of the student.

17. The educational system of claim 16, wherein the evaluation platform for the student includes a personal evaluation from a counselor or a social worker.

18. The educational system of claim 5, wherein the circuitry further includes an interface with one or more local, regional, or federal government databases.

19. A method of establishing an educational system, comprising:
allowing a teacher, through an assignment and grade posting application, to
post an assignment to one or more students;
receive a posted completed assignment by the one or more students;
post one or more grades for the corresponding posted completed assignments;
post a link or embedded tutorial associated with an incorrect or incomplete response for one or more of the posted completed assignments;
receive one or more follow-up responses to the graded assignments viewed by the one or more students;
allowing an instructor, through a tutoring application, to
post an advertisement for a tutoring service;
reply to posted inquiries from one or more students;
arrange one or more tutoring sessions with the one or more students;
conduct the one or more tutoring sessions;
allowing a teacher, principal, or administrator, via a web server, to
stream one or more live educational events;
post one or more recorded educational events;
provide a user interface for viewing the live and recorded educational events;
allowing an employer, through a jobs database and application, to
post one or more job advertisements;
receive one or more student applications in response to the one or more job advertisements;
verify the one or more received student applications for meeting posted qualifications;
forward the verified one or more received student applications that met the posted qualifications to a jobs center;
provide an appointment schedule for interviews offered by an interested posting entity to a qualified student;
allowing a teacher, principal, or administrator, through a classroom viewing application, to
provide a log-in interface for an outside entity to view a classroom in session;
verify log-in credentials of the outside entity;
confirm authorization of the outside entity to view the classroom in session;
provide a viewing of the classroom in session after the verification and confirmation;
allowing an instructor, through a student evaluation application, to
provide a completed evaluation of a student by the instructor;
schedule an appointment with the student to discuss the completed evaluation;
receive responses from the evaluated student; and
allowing a student, through a teacher evaluation application, to
provide a completed evaluation of a teacher by the student;
schedule an appointment with the student to discuss the completed evaluation;
receive responses from the evaluated teacher.

20. A non-transitory computer-readable storage medium having computer-readable instructions embodied thereon, that when executed by a computing device, executes a method comprising:
allowing a teacher, through an assignment and grade posting application, to
post an assignment to one or more students;
receive a posted completed assignment by the one or more students;
post one or more grades for the corresponding posted completed assignments;
post a link or embedded tutorial associated with an incorrect or incomplete response for one or more of the posted completed assignments;
receive one or more follow-up responses to the graded assignments viewed by the one or more students;
allowing an instructor, through a tutoring application, to
post an advertisement for a tutoring service;
reply to posted inquiries from one or more students;
arrange one or more tutoring sessions with the one or more students;
conduct the one or more tutoring sessions;
allowing a teacher, principal, or administrator, via a web server, to
stream one or more live educational events;
post one or more recorded educational events;
provide a user interface for viewing the live and recorded educational events;
allowing an employer, through a jobs database and application, to
post one or more job advertisements;
receive one or more student applications in response to the one or more job advertisements;
verify the one or more received student applications for meeting posted qualifications;
forward the verified one or more received student applications that met the posted qualifications to a jobs center;
provide an appointment schedule for interviews offered by an interested posting entity to a qualified student;
allowing a teacher, principal, or administrator, through a classroom viewing application, to
provide a log-in interface for an outside entity to view a classroom in session;
verify log-in credentials of the outside entity;
confirm authorization of the outside entity to view the classroom in session;
provide a viewing of the classroom in session after the verification and confirmation;
allowing an instructor, through a student evaluation application, to
provide a completed evaluation of a student by the instructor;
schedule an appointment with the student to discuss the completed evaluation;
receive responses from the evaluated student; and
allowing a student, through a teacher evaluation application, to
provide a completed evaluation of a teacher by the student;
schedule an appointment with the student to discuss the completed evaluation;
receive responses from the evaluated teacher.
